(19) United States
(12) Patent Application Publication
(10) Pub. No.: US 2007/0026370 A1
(43) Pub. Date: Feb. 1, 2007

(54) Karaokesystem

(75) Inventor: Olav Bokestad, Goteborg (SE)

Correspondence Address: YOUNG & THOMPSON, 745 SOUTH 23RD STREET, 2ND FLOOR, ARLINGTON, VA, 22202, US

(73) Assignee: ENGINE AB, GOTEBORG (SE)

(21) Appl. No.: 10/570,148

(22) PCT Filed: Aug. 27, 2004
(86) PCT No.: PCT/SE04/01240

§ 371 Date: Mar. 1, 2006

(30) Foreign Application Priority Data
Sep. 1, 2003 (SE) 0302341-3

(51) Int. Cl. G09B 5/00

(52) U.S. Cl. 434/307 A

(57) ABSTRACT

A new karaoke system intended for use in private homes. The complete system is included on a Karaoke-DVD-Disc playable in a DVD-player intended for use in private homes. The system is manoeuvred by the remote control of the DVD-player and program instructions on the DVD-disc. A microphone with a SCART-connector can be connected between the DVD-player and the TV-set. The music-video, the text of the lyrics and the songs are stored on the DVD-disc. The sound and the pictures are presented on the TV-set.

### FIELD OF THE INVENTION

The present invention relates to a karaoke system intended for use in private homes. Karaoke is a form of entertainment generally offered at bars or clubs, in which people take turns to sing popular songs into a microphone over pre-recorded backing tracks of music. The singer can see the text of the song (the lyrics) flowing on a monitor screen, often with a background picture, for instance a beautiful landscape. The voice of the singer is mixed together with the pre-recorded backing track and transmitted from a loudspeaker. The equipment used is often rather expensive and complicated. To find a future for karaoke in private homes resources already existing in the homes have to be utilised.

### BACKGROUND OF THE INVENTION

In the European patent application with publication number EP 0869 475 B1 a karaoke system suitable for karaoke bars is described. The system is based on a computer and thereby complicated and expensive. The system includes:
storage media for the pre-recorded backing track with the music of the song
storage media for the background pictures
equipment to read the stored information and transfer it into a signal
a microphone
a display unit where the pictures and the flowing text of the lyrics of the song to be sung by the singer can be presented
a mixer mixing the voice signal from the microphone and the pre-recorded backing track to a mixed signal
A sound emitting installation where the mixed signal can be transmitted (audio system)

The system is offering a large and varied set of pre-recorded backing tracks and background pictures. In spite of this possibility the background pictures is often a beautiful landscape or a non-figurative picture. The system has capacity to offer high quality of the pre-recorded music and animated pictures or film. Public karaoke clubs or karaoke bars are common and popular in Asia and especially in Japan.

In the American patent application with publication number US 2002/0184994 a simple karaoke system intended for home and children use is described. To reduce the cost, an ordinary television set is used to display the picture and the mixed sound. The picture, the pre-recorded music track and the text of the lyrics are read from a memory device in the unit. Because of the need to keep a low price necessary for this group of customers the memory is limited and the system can not present high quality of music or a good choice of background animated pictures. The system can also be complicated to connect to the television set because it has three connectors that has to be connected correctly.

Another parallel development is the increasing use of DVD-players in the homes. They are installed for showing films recorded on optical discs in the homes and are normally connected to the television set but they can be equipped with an incorporated display unit. A DVD-player is an apparatus that can read information stored on a DVD-disk. DVD is short for “Digital Versatile Disc” and was introduced 1996. Data is stored in the same way as on a CD-disc in a spiral track of reflecting “bumps” and non-reflecting “holes” that can be read by a laser beam. By making the tracks narrower than 0,75 micro meters, 4,7 Gbyte of information or more can be stored in every layer. It is possible to have 4 or more layers on a disc. This is much more data than can be stored on a CD-disc. Today there are several standardised formats like DVD-Video, DVD-ROM, DVD-R, DVD-RW and new formats are coming.

A development trend in the music line of business which also is an important background of this invention is that when songs, singing artists or musician groups are to be introduced a so called music video is often produced. A music video is a sequence of pictures where the artist or the musician group performs the song and sings the lyrics to the music. These music videos are used to promote the artist or artists and the song and are for example sent to different television channels. In this text we will call the artist or the group performing the song on the music video the original artist.

### SUMMARY OF THE INVENTION

The aim of this invention is to be able to offer a karaoke system intended for use in private homes that can play a large choice of high quality music and present animated pictures with the original artist to a low price. This is made by placing program instructions on a DVD-disc playable in an ordinary home DVD-player. In this way instructions are presented on the display unit on how to use the remote controller for the DVD-player to control the karaoke system. The system is advantageous to use together with the karaoke microphone according to an earlier Swedish patent application (0300510-6) by the same inventor.

### BRIEF DESCRIPTION OF DRAWINGS

FIG. 1 Shows a schematic picture of the main menu presented on the display unit with a jukebox in the centre according to the invention.

FIG. 2 Shows an example of the karaoke menu presented on the display unit.

FIG. 3 Shows an example of the picture on the display unit supporting the choice of soundtrack at the same time as the picture sequence is displayed (the karaoke window).

### DETAILED DESCRIPTION OF THE PREFERRED EMBODIMENT

Karaoke singing is very popular in Asia especially in Japan. It is often enjoyed by employees together attending a karaoke bar or karaoke club where special equipment for karaoke is on hand. Public karaoke clubs has not reached the same popularity in Europe and Sweden. The aim of this invention is to make the karaoke singing popular in Sweden and Europe. Because of the European cultural differences to Japan it is expected to be enjoyed more in private homes. There the complicated and expensive equipment developed for karaoke clubs is not suitable. To make the system popular in private homes it has to utilise equipment already on hand in the home intended for other uses and offer a large varied choice of songs by many different artists (song in this text is a piece of music associated with a text of lyrics). The development of optical discs and players for them creates here a possibility. Now, the use of these players in form of DVD-players are increasing in private homes. The players are used to show animated pictures and sound on the television set or the audio system that have been installed in the private homes since long. By using these resources the new karaoke system according to the invention can be produced to a lower cost.

The invention is a karaoke system intended for use in private homes that can offer a large choice of music and pictures and can be used without any special karaoke equipment except a karaoke-DVD-disc with special program instructions readable by the DVD-player. The system utilises the TV-set or the display of the DVD-player to show the background films or sequences of pictures and the flowing text of the lyrics to the singer and play the sound. The singer places himself so he can see the text, hear the music and sing to it.

It is advantageous to use the karaoke-DVD-disc together with the karaoke equipment with a microphone and SCART-connectors according to an earlier invention by this inventor. If the DVD-player or the audio system is equipped with a microphone connector (where the karaoke singer can sing in a microphone connected to it whereas the singing is mixed into the sound) this karaoke DVD can be used without any additional karaoke equipment. It is also possible to use this karaoke system without a microphone or with a separate microphone amplifier.

With this method the karaoke singer can get access to the display unit, audio system, music and picture reading equipment and the microphone needed to compose a karaoke system without having to obtain them only to be able to sing karaoke. Neither this karaoke system needs any computer system to control and coordinate all the devices like in a big karaoke system intended for karaoke bars. The karaoke system according to this invention is thereby cheap to produce once the development of program instructions used to control the DVD-player and show guiding information on the TV-set is finished.

By using an ordinary DVD-player to play the karaoke-DVD-disc the system gets access to a device that can handle a large amount of information and can read and act on program instructions. The storage volume on a DVD-disc unlike older optical discs can store several of the above music videos on one disc. It is also seen as indispensable for a karaoke system to be able to offer the karaoke singer a big choice of songs from many different artists without having to change disc in the player.

The program instructions can be put together in many different ways to give the possibility to choose which song with associated synchronised picture sequence to be played. The player shall also be able to choose which of the sound tracks among for instance tracks with or without vocalist and in different pitches to be played. Beyond that other possibilities can be on hand.

To simplify the explanation of the system we will start with the idea of a collection of picture sequences with the associated song and the lyrics of the song. Different from earlier karaoke systems where the song is the main concept and the producer chooses a suitable background picture the concept here is the music video or picture sequence. To one music video there is only one song associated. One can think of it as the sound track on a video tape. The song (music and lyrics) is synchronised with the performance of the artist shown in the picture sequence. Though for karaoke use we only want the music, not the singing of the lyrics by the artist, since the intention with karaoke is that the karaoke singer himself is to sing the lyrics to the music. The DVD-technology offers here an excellent possibility because it can handle more than one sound track synchronised with one picture sequence. One of the sound tracks can be the original track from the music video and another track the same music but without hearing the singing of the lyrics by the original artist.

The aim of the music video at production is to be promotion material or sales support to the song, introducing the sales of a sound recording where the artist is singing the lyrics associated to the music. Because of this it exists for sale in shops such a recording for instance on a CD disc or a tape cassette. It is also probable that the karaoke singer himself has heard the same artist sing the same song (the lyrics to that music) as he can hear on the Karaoke-DVD-disc. To use the music video, meaning that the original artist is performing the song, increases the interest from the users significantly and is thereby expected to increase the sales of the karaoke-DVD-disc. This has not earlier been done and is hardly possible on the karaoke system according to the above American application since the capacity of the memory is restricted.

To use the music video in a karaoke system in this way outside the intention of it gives access to a huge amount of interesting, but above all, already produced material. The producer of the Karaoke-DVD-disc is thereby not obliged to produce new special picture sequences and recordings. This gives an additional decrease of the cost of the karaoke system according to the invention.

The human voice can have different ranges of pitch. It is thereby possible that the karaoke singer can not sing in the same pitch or key as the original artist. To support this more sound tracks in another key synchronised with the picture sequence can be added, for instance three intervals higher respectively three intervals lower. Sound tracks with music and lyrics in these keys can also be added.

It is possible to have more sound tracks than these six but in the below described embodiment these six categories of sound tracks will be used.

The karaoke system can be described as an optically readable disc which can be played in a DVD-player intended for use in private homes which transmits electrical signals transferring picture and sound information recorded on the above optical disc where sequences of the picture information is synchronised with one or more sound tracks with music and in the picture information is included text of the lyric associated with the above music where all sound tracks synchronised with one picture sequence represent the same song and the picture information shows an artist performing the lyrics associated with the above music and there is available in the music stores at least one recording where the above artist is performing the above lyrics to the above music.

Below is described how the system can work together with a user as an example.

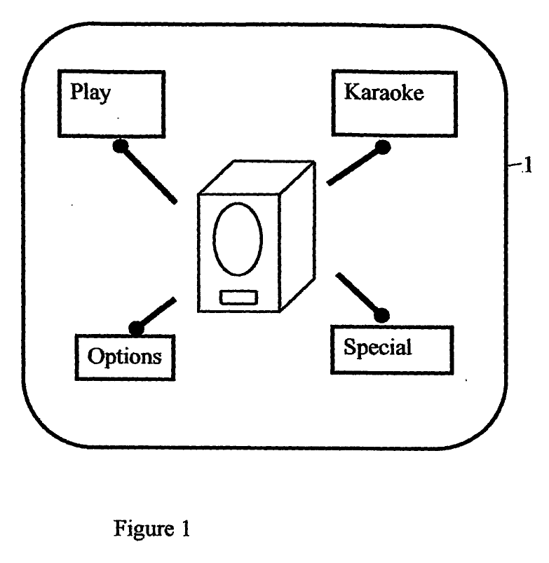

When the Karaoke-DVD-disc is inserted into the DVD-player a start picture is shown on the TV-set. The start picture here called the main menu offers a number of choices associated with different buttons on the remote controller or which can be chosen with help of the arrow buttons. In this example it is a stylistic jukebox (number 1 in FIG. 1) offering four alternatives. The advantage of using a jukebox in the picture is that it associates to choosing music to be played in a public area suitable for a performance. The four choices are:
1. Play—to play all picture sequences synchronised with music in a predefined order. When the playing starts the Play window is displayed.
2. Karaoke—to sing karaoke and leading to a Karaoke menu
3. Options or play order—leading to a Play order menu where the play order can be chosen
4. Special or Information—leading to an Information menu which can contain information about the artist, interviews and other things that the customers like to hear, see or read, for instance a dance course.

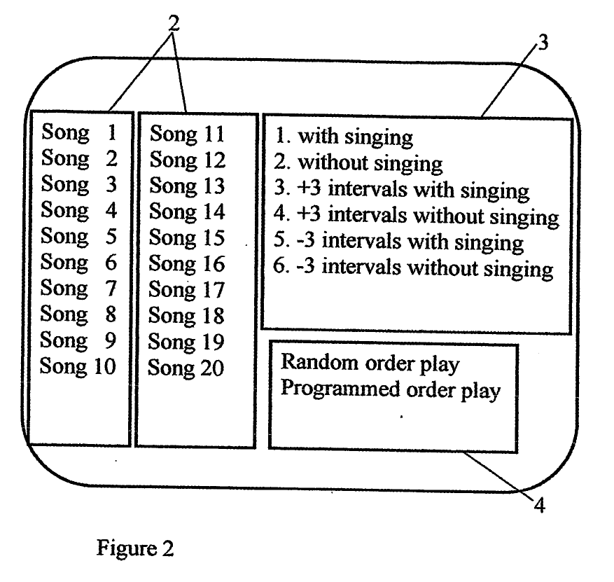

The Karaoke menu shows all songs on the disc and gives possibility to choose between them with help of the remote control. As part of the menu it is possible to choose category of sound track. It is also possible to choose if the songs are to be played in a predefined order, a random order or an order programmed by the user. When these choices are done the Karaoke-play-window is displayed on the TV-set. FIG. 2 shows an example of a Karaoke-menu with windows for choice of song 2, window for choice of sound track 3 and window for choice of play order 4.

The Playorder-menu shows all songs on the disc making it possible to choose among them with the remote control. It is also possible to choose if the songs are to be played in a predefined order, a random order or an order programmed by the user. When these choices are done the Play-window shows up on the TV-set. This menu is similar to the Karaoke-menu.

The Information-menu shows the information alternatives choosable by the user. When the choice is made the alternative is played with picture and sound. During play the user has control over the usual video functions like Stop, Fast forward and Rewind. When the part is finished or the user stops it the player returns to the Information-menu.

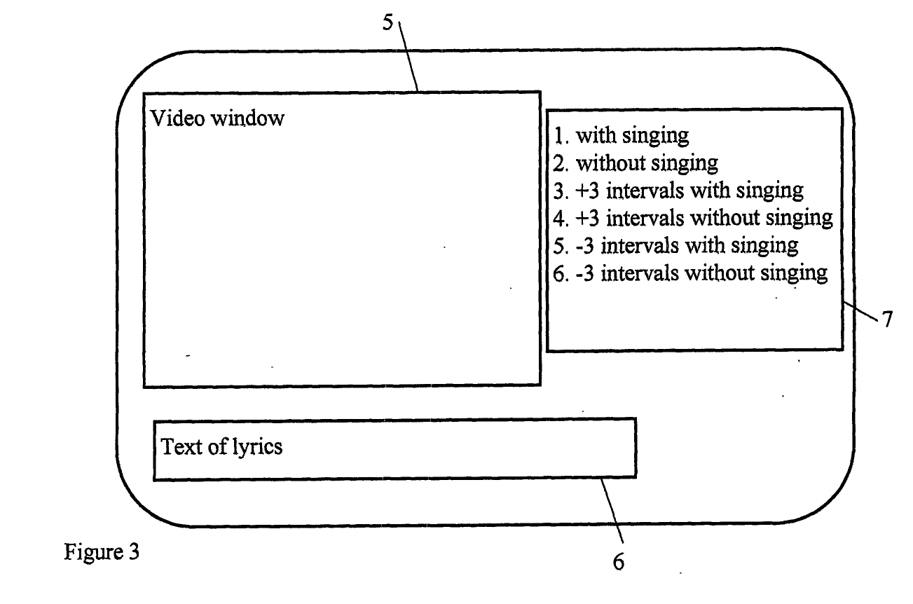

The Karaoke-play-window shows the picture sequence (the music video) and the text of the lyrics flowing synchronously so that the word to be sung is marked, for instance with another colour, or underlined. Additionally there can be a menu to change to another of the synchronised sound tracks. During play the user has control over the usual video functions like Stop, Fast forward and Rewind. When the part is finished or the user stops it, the player returns to the Karaoke-play-menu. FIG. 3 shows an example of the Karaoke-play-window with a window to show the picture sequence 5, a window for the text 6 and a window for change of sound track 7.

The Play-window shows the music video (the picture sequence) at the same time as the original sound track with the artist singing to the music is played. During play the user has control over the usual video functions like Stop, Fast forward and Rewind. When the part is finished or the user stops it, the player returns to the Playorder-menu if the user chose the Play-window from there. If the user instead chose the Play-window by choosing play on the main menu the player will return to the main menu.

The number of choices and the hierarchy among them can of course be organised in another way but the minimum is that the user can choose song and sound track with help of the remote control and the information presented on the display. It is a big advantage if the choices or the so-called dialogue can be made as easy to understand and as intuitive as possible. One good way is to make the choices with help of the so-called arrow buttons and the OK-button on the remote control instead of as usual with the audio-button. The choice is then practised by moving a so called cursor, i.e. a symbol on the screen that moves to different buttons shown on the screen. The buttons represent different sound tracks and are well marked to make the user understand which of the sound tracks it represents. When the cursor reaches a button on the screen it can be lit up or change appearance in another way to make the user intuitively understand that it is marked, and when the user presses the OK-button the player will start to play the sound track that the marked button represents. It is also improving the understanding and making it more intuitive that the user has access to the choice of sound track on the same time as he sees the picture sequence and hears one of the sound tracks being played. The karaoke singer can thereby easily change to the sound track he wants to play because he can hear the sound of it.

It is also a good advantage that it is possible to include additional services like interviews with the artists and information about them. This is a way to increase the interest in the music, the lyrics and the artist and will thereby increase the sales.

When the karaoke singer has chosen to play several songs in running succession it is an advantage if the same category of sound track is played for every song. For example if the singer plans to sing to the music in normal key, the sound track of the second category (i.e. music without singing of the artist in the same key as on the music video) shall be chosen for the following song. The sound tracks on a DVD-disc are numbered from 1 ascending. The DVD-player continues with the same track number if nothing else is ordered. To play the same category of sound track for every song the categories of sound tracks should be put in the same order fore every song.

An example of such an order is:

Track 1—music with singing by the artist in the same key as on the music video.

Track 2—music without singing by the artist in the same key as on the music video.

Track 3—music with singing by the artist in a higher key than on track 1.

Track 4—music without singing by the artist in a higher key than on track 1.

Track 5—music with singing by the artist in a lower key than on track 1.

Track 6—music without singing by the artist in a lower key than on track 1.

A summary of the advantages of the invention is then:
The karaoke system can be constructed on one DVD-disc and thereby to a lower cost by utilising systems normally on hand in private homes.
The karaoke system can be made attractive by showing the original artist performing the song and thereby reach high volume of sales.
The karaoke system can be made easy to use by the help of clear instructions on the screen so that even children can use it.

The above description presents some preferred embodiments of the invention. Of course other embodiments varied inside the scope of the claims are also covered by this application.

1. An optically, readable disc playable in a DVD-player intended for use in private homes that can generate electrical signals transmitting picture information and sound information recorded on said disc where sequences of the picture information is synchronised with one or more sound tracks with music and in the picture information is included text of the lyrics associated to said music wherein all sound tracks synchronised with one sequence of picture information represents the same song and that one of the sound tracks is in a higher or lower key than the sound track with music and singing of the artist shown in the picture sequence.

2. An optically readable disc according to claim 1 wherein for at least one of the picture sequences, one of the synchronised sound tracks is music with singing of the artist shown in the picture sequence.

3. An optically readable disc according to claim 2 wherein at least one of the sound tracks synchronised with one of the picture sequences is music in a higher key than the sound track with music and singing of the artist shown in the picture sequence.

4. An optically readable disc according to claim 2 wherein at least one of the sound tracks synchronised with one of the picture sequences is music in a lower key than the sound track with music and singing of the artist shown in the picture sequence.

5. An optically readable disc according to claim 2 wherein at least one of the sound tracks synchronised with one of the picture sequences is music and singing. in a higher key than the sound track with music and singing of the artist 14 (15) shown in the picture sequence.

6. An optically readable disc according to claim 2 wherein at least one of the sound tracks synchronised with one of the picture sequences is music and singing in a lower key than the sound track with music and singing of the artist shown in the picture sequence.

7. An optically readable disc according to claim 2 wherein at least one of the sound tracks synchronised with one of the picture sequences is only music or a music and singing where the singing has been removed.

8. An optical disc according to claim 1 wherein is contained program code making it possible, with a remote control to a player for the disc with support from picture information shown on the display unit, to choose one of several picture sequences and one of the sound tracks synchronised with it.

9. An optical disc according to claim 1 wherein different picture sequences showable on the display unit shows different artists.

10. An optical disc according to claim 1 wherein the picture information supporting the choosing of picture sequence shows a juke box.

11. An optical disc according to claim 1 wherein it contains program code making it possible with a remote control to a player for the disc with support from picture information shown on the display unit where the picture sequence is shown on the same time, to choose and change between the associated sound tracks synchronised with it.

12. An optical disc according to claim 1 wherein it contains program code making it possible with the arrow buttons on a remote control to a player for the disc with support from picture information shown on the display unit where the picture sequence is shown on the same time, to choose and change between the associated sound tracks synchronised with it.

13. An optical disc according to claim 1 wherein the categories of associated sound tracks synchronised with one picture sequence are ordered in the same way for more than half of the picture sequences.

14. An optical disc according to claim 1 wherein all the picture sequences can be played in a redefined order by one command.

15. An optical disc according to claim 1 wherein all the picture sequences can be played in a random order by one command.

16. An optical disc according to claim 14 wherein the same category of associated sound track synchronised with one picture sequence is chosen for every picture sequence.
